(19) United States
(12) Patent Application Publication
(10) Pub. No.: US 2025/0243801 A1
(43) Pub. Date: Jul. 31, 2025

(54) Combustion System with Pollution Abatement by Catalysts and Non-Thermal Plasma for Aircraft and Industrial Gas Turbines

(71) Applicant: Baha Elsayed Attia Abulnaga, Bellingham, WA (US)

(72) Inventor: Baha Elsayed Attia Abulnaga, Bellingham, WA (US)

(21) Appl. No.: 18/423,355

(22) Filed: Jan. 26, 2024

(51) Int. Cl. F02C 3/13; F02C 3/36; F02C 7/105; F02C 7/141

(52) U.S. Cl. CPC F02C 3/13; F02C 3/365; F02C 7/105; F02C 7/141; F05D 2210/12; F05D 2220/321; F05D 2270/082

(57) ABSTRACT

The invention being proposed, applies pollution abatement to aircraft and industrial gas turbines. Air from the compressor is divided between primary air for combustion and secondary for dilution, where primary air is directed to a ceramic lined combustion tube where air and fuel are burnt at stoichiometric ratio and then passed through a pollution abatement chamber for non-thermal plasma treating consisting of an electrode rod casing, electrode rods and catalysts between the rod and tube electrodes before rejoining bypass air in a manifold to cool down the flue gases below the creep temperature limit of the turbine stage.

### FIELD OF INVENTION

The field of the invention covers the design of combustion in gas turbines used in the propulsion of aircraft and for industrial power applications with emphasis on reducing pollutants.

### BACKGROUND TO THE INVENTION

Modern airplanes use gas turbines for propulsion in the form of turbofans, turboprops or jet engines. Theu burn Jet A fuel. As the aircraft goes through different stages of flight, from rolling on the tarmac, to climbing, level flight or descent and landing, the powerplants produce pollutants such as Nitrous Oxides, Carbon Monoxide, Carbon Dioxide, Soot. Water vapor produced from the combustion of hydrogen in the fuel, forms contrails. Aviation is anticipated to grow at the rate of 2.9% in the next 20 years, Governments have mandated zero emissions by 2050. The current emphasis on Sustainable Aviation Fuels (SAF) would require very large farmlands to produce fuel. Our invention offers an alternative approach for reduced emissions from aircraft gas turbines, and their industrial derivatives.

Past development has focused on achieving higher operational ratio (OPR) and Higher Turbine Entry Temperature (TET) to achieve higher engine thermal efficiency and to lower specific fuel consumption (SFC). Published references indicate that NOx emissions are lower at a lower OPR.

Experience shows that there is a narrow band between 1670 and 1800 K for combustion of jet fuel, leading to low emissions of NOx and low CO. At moderate pressures, the soot can also be reduced.

The high temperature associated with combustion of fuel would melt the turbine casing and blades. Therefore, most gas turbines operate at an air fuel ratio of 100 to 200 to lower the temperature of flue gases below the creep limit of the turbine blades.

With current aircraft technology operating at an air to fuel ratio of 100 to 200, and catalytic converters are not installed on airplanes as they would be very bulky. However, I propose in my invention to reduce volume of flue gases to be admitted in a pollution abatement device by separating the combustion flux from dilution air needed to cool down to the temperature limits of the blades of the turbine stage.

The principle of the catalytic converter consists of using catalysts to break down the NOx back into atoms of nitrogen and oxygen. In the car industry the catalytic converter is also used to complete the combustion of carbon monoxide.

In order to apply the principle of the catalytic converter to an aircraft engine, I propose that the following stages of combustion
A combustion tube where air and fuel are mixed at the stoichiometric ratio and burned at reduced pressure
A chamber at the discharge of the tube where pollutants are removed from the resultant flue gases by the use of catalysts and non-thermal plasma
A manifold in which flue gases are mixed with cooler dilution bypass air from the compressor to reduce temperature below the creep temperature of the turbine stages.

The hot turbine section consists of a minimum of three stages, a first turbine section or stage to drive the compressor stages, a second turbine stage aerodynamically coupled to the first stage, driving the aircraft turbofan or propeller, and finally a third stage driving the generator for the non-thermal plasma application. This last or third stage converts remaining heat in flue gases that was not used in the previous two stages into electric power, but is not anticipated to exceed 6% of the engine power, needed for final pollution abatement by non-thermal plasma application.

Field experience shows that CO is produced when the combustion occurs with rich mixtures and insufficient oxygen. This also occurs at low power regimes, with low inlet temperatures, low inlet pressure and relatively low equivalence ratio (ratio of fuel to oxidizer at operation divided by stoichiometric fuel to oxidizer ratio). To avoid some of these conditions, I argue that there may be situations when it becomes necessary to shut down or reduce flow through some combustion tubes through their valves, at low power. while running remaining tubes efficiently. The impact is reduced overall pollution.

CO emissions also occur when combustion at stoichiometric ratio occurs at temperatures higher than 1800 K with subsequent dissociation of CO₂. To avoid such a problem, the amount of air is controlled to each combustor tube at the inlet valve through dedicated temperature sensor, a pressure sensor and flow sensor. The control valve at the inlet to the combustion tube may admit more air above stoichiometric ratio in these cases.

To avoid the risk of forming unburned Hydrocarbons (UHC) the fuel atomization is very critical. Risk of inadequate reaction rate, local quenching or incomplete combustion must be mitigated. The design of the fuel injection point is based on creating a very fine atomization at the center of the air nozzle followed by a zone of entrainment, throat and further compression of flue gases.

I believe that this approach offers some advantages leading to a faster reduction of pollutants compared to alternatives
It should be lighter than some of the new concepts that require thick wall tanks to contain the high pressures needed for maintain hydrogen in a liquid form
It could be lighter than electric batteries for long range operation
It may use current technology for gas turbine manufacture
It could be retrofit to existing planes earlier than electric batteries, aluminum powder fuel or liquid hydrogen

My invention uses modern PLC and Computer technology to control the engine performance through take-off, cruise, climb and landing by opening and closing different numbers of tubes and adjusting the flow of air and fuel to each.

My approach therefore focuses on a new combustor system for existing airplanes with a system to capture emissions. I am aware that this implies to continue to use jet fuel and hydrocarbon-based fuels, but this approach can be extended to future fuels too.

The curves of Liu (2017) suggest that low NOx based on CAEP1 or ICAO 1986 was stated as established at 40+2xOPR (g/kN), CO at 118 g/kN, and UHC at 19.6 g/kN.

At the OPR of 25, this is equivalent to 90 g/kN. Tougher regulations aim at reducing these emissions further down have been adapted since 1986.

My design is available in two options for subsonic and supersonic flows. I shall describe the principle first for subsonic tubes as illustrated in FIG. 2.

Each subsonic tube is further divided into
An expansion length to convert inlet pressure from the compressor into high-speed kinetic energy
An injection of fuel at the center of the nozzle
A transition throat for high-speed combustion of fuel droplets
A compression length with gradual increase of the tube diameter downstream the throat to convert back kinetic energy back into pressure
A chamber to apply catalysts and non-thermal plasma to break down the pollutants
A manifold to merge with bypass air from the compressor

The subsonic combustion tube (FIG. 3) is designed similar to a venturi tube and is divided in 3 zones of entrainment, throat and compression, ending with a zone for catalytic conversion.

The incorporation of swirling vanes in the venturi combustor creates a radial and tangential distribution of pressure and velocity as in a vortex. The one-dimensional analysis therefore focuses on average values of pressure, velocity and density.

A certain pressure loss is to be expected from the compressor, so the pressure at the entry of the combustor is Pₐ. The temperature at the entry of the nozzle is Tₐ.

From Bernoulli's equation the flow across the nozzle of the combustor is expressed as

$${P}_{a} + \frac{1}{2} {ρ}_{a} {V}_{a}^{2} = {P}_{b} + \frac{1}{2} {ρ}_{b} {V}_{b}^{2} \qquad ( 1 )$$

Pₐ=average static pressure at entry of nozzle
ρₐ=density of air at entry of combustion tube
Vₐ=average velocity of air at entry of combustion tube
P_{b}=average static pressure upstream throat at end of entrainment zone
ρ_{b}=density of air at end of entrainment length upstream the throat
Vₙ=average of velocity air at discharge of nozzle

From the mass conservation equation, considering subsonic flow of air into the combustion tube

$$\frac{{dM}_{a}}{dt} = {ρ}_{a} {V}_{a} {A}_{a} = {C}_{db} {ρ}_{n} {V}_{n} {A}_{n} \qquad ( 2 )$$

Aₐ=cross sectional area of flow at inlet to the combustion tube
C_{db}=discharge coefficient through the entrainment length
A_{b}=cross sectional area upstream the throat ate end of entrainment length

The pressure at the end of the entrainment length

$${P}_{n} = {P}_{a} + \frac{1}{2} {ρ}_{a} {V}_{a}^{2} - \frac{1}{2} {ρ}_{b} {V}_{b}^{2} = {P}_{a} + \frac{1}{2} {ρ}_{a} {V}_{a}^{2} - \frac{1}{2} {{ρ}_{b} [ \frac{{ρ}_{a} {V}_{a} {A}_{a}}{{C}_{db} {ρ}_{b} {A}_{b}} ]}^{2} \qquad ( 3 )$$

$${P}_{n} = {P}_{a} + \frac{1}{2} {V}_{a}^{2} [ {ρ}_{a} - {{{ρ}_{b} ( \frac{{ρ}_{a}}{{ρ}_{b}} )}^{2} [ \frac{{A}_{a}}{{C}_{d} {A}_{b}} ]}^{2} ]$$

The cross-section of the venturi gradually decreases towards the throat forming a zone of entrainment in which fuel and air mix and combustion occurs therefore at an average pressure lower than the compressor pressure to minimize NOx emissions.

Combustion causes a change of temperature, pressure and density towards the throat at the end of the entrainment zone of the venturi. The conditions at the throat are therefore
Pₜₕ=average static pressure of flue gases at the throat
ρₜₕ=density of flue gases at the throat
Vₜₕ=average velocity of flue gases at the throat
Tₜₕ=average temperature of flue gases at the throat

In the final compression length of the venturi pressure increases to the value at the entry to the catalytic converter through the zone where catalysis is added.

$${P}_{th} + \frac{1}{2} {ρ}_{th} {V}_{th}^{2} = {P}_{ct} + \frac{1}{2} {ρ}_{ct} {V}_{ct}^{2} \qquad ( 4 )$$

P_{ct}=average static pressure of flue gases at the entry to the catalyzer
ρ_{ct}=density of flue gases at the entry to the catalyzer
V_{ct}=average velocity of flue gases at the entry to the catalyzer

$${V}_{th} = \sqrt{[ \frac{2 ( {P}_{c t} - {P}_{t h} )}{{ρ}_{t h}} + \frac{{ρ}_{c t}}{{ρ}_{t h}} {V}_{ct}^{2} ]}$$

The throat velocity is expressed

$${V}_{th} = \sqrt{[ \frac{2 ( {P}_{c t} - {P}_{t h} )}{{ρ}_{t h}} + \frac{{ρ}_{c t}}{{ρ}_{t h}} {V}_{ct}^{2} ]} \qquad ( 5 )$$

Density changes are associated with changes of temperature and pressure in the compression stage of the venturi.

A small pressure loss occurs across the catalyzer and common manifold for all combustors. Dilution air is added in the common manifold so the flue gas and dilution air mixture enter the turbine stage at temperature T₃, pressure P₃, density ρ₃ downstream the catalyzer section. The pressure of the cooling air must be controlled through a valve to allow good mixing with flue gases from the individual combustor tubes.

The following example illustrates operation of the combustion tube operating at an overall pressure ratio of 25. Based on an OPR of 25, the temperature rise through the compressor is expressed as

$${T}_{o 2} - {T}_{a} = \frac{{T}_{a}}{{η}_{c}} [ {( \frac{{P}_{02}}{{P}_{a}} )}^{{( γ - 1 )}^{} / γ} - 1 ]$$

At inlet temperature Ta=288K, compressor efficiency η_{c}=0.85, OPR 25; γ=1.4

$${T}_{o 2} - {T}_{a} = \frac{288}{0.85} [ {( 25 )}^{{( γ - 1 )}^{} / γ} - 1 ] = 511 K$$

Temperature at the exit of the compressor is therefore 799 K

At inlet temperature Ta=288K, compressor efficiency η_{c}=0.85, OPR 25; γ=1.4

$${T}_{o 2} - {T}_{a} = \frac{288}{0.85} [ {( 25 )}^{( γ - 1 )} {/}_{γ} - 1 ] = 511 K$$

Temperature at the exit of the compressor is therefore 799 K

The total air mass flow rate through the combustion system is 120 kg/s. There are 6 combustors, so the flow through each combustor tube is 20 kg/s. At the density of 9 kg/m³; the resultant air flow rate is 2.22 m³/s.

The inlet diameter of the combustor is 300 mm. The inlet velocity=31.4 m/s. The discharge diameter at the throat is 125 mm. Assuming a discharge coefficient of 0.9

The cross-sectional area Aₙ=0.01227 m².

$${P}_{n} = {P}_{a} + \frac{1}{2} {V}_{a}^{2} [ {ρ}_{a} - {{{ρ}_{n} ( \frac{{ρ}_{a}}{{ρ}_{n}} )}^{2} [ \frac{{A}_{a}}{{C}_{d} {A}_{n}} ]}^{2} ]$$

We can assume that the flow is isentropic, the calculations converge for
ρₙ=8.55 kg/m³
Vₙ=211 m/s
P₂=2.3 MPa (a reduction of 200,000 Pa)

The velocity Vₙ at the exit of the nozzle is very high and will entrain any unburnt hydrocarbons towards the combustor throat into the flame.

However, the reduction of pressure is more complex since the temperature rises at the exit of the nozzle due to the presence of the flame.

Since the stoichiometric ratio is 15, fuel is added at the rate of 1.33 kg/s.

As the temperature rises towards 1800 K through the flame, the density of the flue gases decreases by the rise of temperature but increases due to the consumption of fuel. The compression length from the throat to the section where the flue gases come in contact with the catalyst, must therefore be designed to the conditions at the inlet to the turbine ρ₃, T₃ and P₃.

For the supersonic tube that may be used in the future, pressure is reduced by using a divergent nozzle in which fuel is added at the walls into a transition throat. Pressure is increased back by gradually decreasing back the cross section of the combustor.

If we consider that current technology relies on an air to fuel ratio of 100 to 200 (Cohen (1978)) to cool down the flue gases below the creep temperature of turbine blades, the dilution air would normally be between 85 and 185 folds the fuel or between 113 and 247 m³/s. If for example we consider EP patent application 2 392 796 A1, the entire air volume for combustion and dilution would have to pass through a bulky heat exchanger. However, in one of my configuration (FIGS. 2,3), I present the case that only the air needed for combustion at the stoichiometric ratio needs to pass through a heat exchanger, with a corresponding smaller portion of the gas turbine gas turbine. This results in a much smaller and lighter heat exchanger than proposed by EP patent application 2 392 796 A1.

Rubin M. in European Patent Application EP0271369 A2 discusses the use of a shell and tube heat exchangers for the entire flow of the compressor to pre-heat the air feeding a catalytic combustor using the turbine discharge gases. This approach is not suitable for an aircraft at an air to fuel ratio of 100 to 200 as it would lead to a very heavy heat exchanger to be transported during flights at a higher overall fuel consumption. Whereas I propose to focus on a smaller stream at the stoichiometric ratio in my design.

At some time in the future as supersonic compressors start to be used commercially, the combustor can be modified to a different shape (FIG. 4). At supersonic flows, the cross section of the tube would have to be increased first to reduce pressure to a larger diameter throat followed by gradual reduction of cross-sectional area to increase back the diameter. The change of gas density through the tube, is then a function of the Mach Number

The work of Jonsdottir et al (2019) suggest that non particle volatile emissions from aircraft gas turbines such as the CFM56-7B26 turbofan, the world's most used aircraft turbine is smaller in diameter than internal combustion engines and more invasive and dangerous on tarmac workers particularly during idling on the ground prior to take-off. Sometimes it is important to coalesce, coagulate or flocculate, or apply an electrostatic field to very fine particles to capture them or grow them into larger diameter before capturing them. These are standard practices in the mining industry to very small sizes in the sub 44 microns. This would be a challenge between the combustor and the turbine as any large and hard particles could lead to wear problems. It has already been noticed in the past that carbon deposits from the combustor could be with high hardness and damage turbine blades (Cohen et al (1978)). Flocculation or coagulation are not feasible as they involve water.

Non-equilibrium plasma (sometimes called non-thermal) plasma is an interesting technique to explore to promote catalysis and promote capture of non-volatile particles. It would use very high temperature electrons generated by an electric field across the catalysis honeycomb. It is applicable up to temperatures of 2750 K. Combining non-equilibrium plasma with catalysis in a combined mode increases efficiency of capturing numerous pollutants.

The concept we are proposing where as air from the compressor is applied at the center of the burner and then converted into a high-speed jet to entrain small droplets of fuel into a flame, our approach consists of reducing air pressure for lower NOx production.

The temperature of 1800 K could melt some metals. The combustor tube should therefore be manufactured of a high strength ceramic material such as the SIALON (Silicon Aluminum Oxygen Nitrogen family) or enclosed in a cooling air (or water) jacket. We have assumed that some of the air from the compressor could be pumped through an air jacket surrounding the combustion tube before merging at the discharge from the catalyst converter.

The selection of catalyst for aircraft propulsion is critical from the point of view of weight. A light option would consist of injection droplets of liquid catalyst that could be replenished at the end of each flight. Selective catalyst reduction uses a reductant such as anhydrous ammonia (NH₃), aqueous ammonia (NH₄OH) or urea CO(NH₂)₂. These reactions occur require the reductant to evaporate into the flue gases, Data is available at optimum temperatures of 630 to 720 K and would be much lower than flue gases coming out of the combustor. Tests must therefore be conducted at the higher temperatures of the flue gases in the combustor.

U.S. Pat. No. 4,413,470 for example discusses the use of a zircon composite for substrate (with melting temperature of 1950 K, with catalyst consisting of an active component of Palladium and a washcoat of stabilized alumina in a catalytic combustor for a stationary gas turbine. This invention proposes a combustor followed by a catalytic unit but does not include non-thermal plasma treatment. The design is for the entire flow from the compressor and does not divide between air needed just for combustion at the stoichiometric ratio and air needed for dilution to lower the temperature of flue gases to the creep limit of the turbine stage.

Steinwandel and Bayer discuss in their European patent EP2 392 796 A1 the installation of a catalytic converter on a turboshaft engine but propose to reduce the temperature of the exhaust gases through a heat exchanger to a range below 700 K, to allow for the use of a full range of catalysts. This solution is more limited to smaller aircrafts and helicopters. The patent by Steinwandel does not discuss the application of non-thermal plasma to treat the exhaust gases of the turboshaft engine. Our approach relies more on using higher temperature catalysts, combined with non-thermal plasma treatment on a smaller stream of flue gases obtained from combustion at the stoichiometric ratio, rather than treating the entire mass of diluted flue gases with an air to fuel ratio in the range of 100 to 200. Such heat exchangers could become very cumbersome on large transport airplanes. While I am aware that the use of hot temperature catalysts such as Alumina, or metal oxides, or ceramic based catalysts, has a more limited range, the volume they would occupy would be smaller than if lower temperature catalysts were used on the entire volume of diluted exhaust gases.

Due to weight restrictions, a rotating heat exchanger would be lighter than a traditional tube and shell heat exchanger for aircraft propulsion.

Willis J. W, P. Berner, G. Pont and J, Wacknov “Integrated Power Generation System with Catalytic Reactor”—in US Patent Application 2004/0100101 A1 Published May 27, 2004, discuss the use a catalytic reactor on the entire discharge flow of the turbine upstream a heat recuperator pre-heating the combustion air. This design will be difficult to implement on an aircraft as the entire flue gas flux obtained at air to fuel ratio of 100 to 200 would need to be treated, while in my design I propose to separate the combustion air needed at the stoichiometric ratio from the required dilution air (which is typically in the range of 85 to 185 times the fuel mass) and treat all the pollutants in a very concentrated form from a combustion tube being operated at the stoichiometric ratio, which would be 9.5 for natural gas in industrial gas turbines and 15 in aircraft gas turbines with jet fuel. Therefore, US patent application 2004/0100101 A1 would lead to a much larger and heavier recuperator than what I am proposing in my invention, In the case of aircrafts this would be an important weight penalty, leading to more fuel consumption during flight. In the case of large industrial gas turbines in the range of 150 to 300 MW a catalytic converter for the entire gas turbine exhaust would still be a much more expensive device to use than a unit operated at the stoichiometric ratio. US patent application R. W Gordon and R, Chute—in US Patent Application 2002/0095939 A1 Published Jul. 25, 2002, discuss the use of a recuperator on a micro-gas turbine engine, but do not feature any catalytic nor non-thermal plasma treatment of emissions.

To avoid the complication of equipment to supply toxic ammonia, Imanaka & Masui have proposed direct NOx decomposition with inorganic catalysts as copper-ion zeolites (Cu-ZSM-5), perovskite type oxides and rare-earth oxides. Direct reduction may be the preferred route with aircraft engines as it does not depend on the use of reductants. Metal based catalysts are used at high temperatures in the range of 600 to 900 K in the oil & gas industry based on metals such as molybdenite, zircon, platinum, chromium-promoted iron oxide cobalt and nickel in hydrocracking applications (Abulnaga 2021). With proper design their use should be possible with aircraft engines with a ceramic matrix. Alumina oxide such as non-porous γ-Al₂O₃ catalysts are considered suitable to a temperature of 1400 K. Molybdenum has a melting temperature of 3000 K. MoS₂ combined with Cobalt is also used as a catalyst for hydrodesulfurization in the petroleum industry.

Galligan (2008) discusses the use of air treatment catalysts for aircraft in the patent application US20100152032A1, particularly for destruction of ozone. A number of catalysts such as manganese dioxide, a refractory metal oxide such as alumina, zirconia, titania and silica were proposed for the walls of the catalytic converter

Metal-based catalysts eventually lose activity by a process called “poisonous”—In the oil industry they must be regenerated or disposed. In some hydrocarbon refineries this may be down over a period of few years. A special catalyst cartridge can be designed for replacement after a certain number of flights, (after so many hundred hours of flights), based on field experience.

Catalytic combustors are honeycomb ceramic structures covered with a noble metal such as palladium or platinum. They are used on wood stoves to burn the smoke at temperatures of the order of 840 K to 1100 K. Willis et al in patent application US 2004/0100101 A1, and General Electric—in Patent JP2591866B2—suggest that at start-up, the temperature of air from the compressor may be too low. 2004/0100101 A1 uses a low pressure secondary catalytic reactor downstream the turbine stage, upstream the recuperator and a primary catalytic reactor upstream the turbine stage for the entire flow but does not propose to use a non-thermal plasma application. I believe that the non-thermal plasma application is more suitable for high temperature and lighter on an aircraft and can compensate for the restriction to hot catalysts as in the design I have proposed. The amount of plasma treatment can also be increased at start-up until the high temperature for the catalysts is reached.

The combination of combustion tube and catalyst cartridge may be longer than conventional combustion systems of current aircraft engine. We have therefore proposed that the combustion and catalyst system be on the side of the engine or an integral part of the wing. This is not the usual approach in modern aircraft engines when the manufacturer of the airplane and the manufacturer of the aircraft are separate entities. However, it should be possible at some point to develop collaboration between the two entities.

Earlier efforts to use exclusively non-thermal plasma for treating flue gases led to new problems (Pasquiers, 2004). Tt was noticed that NO was oxidized in the air plasma to form other oxides like NO₂ and N₂O₅, and reactions of oxygen atoms or hydroxyl radicals produced by the discharge combined with VOCs could lead not only to H₂O and CO₂ but to a number of undesirable by-products following the partial oxidation of the molecule. Research in the last 20 years has therefore shifted towards applying non-thermal plasma in combination with the use of catalysts. The combined application of catalysts and non-thermal plasma at the tail end of a gas turbine requires to install a small generator on the shaft of the turbine to generate an electric field across the end of the combustor.

The application of the plasma treatment to hot flue gases at 1800 K can be characterized as “hot non-thermal plasma”, as thermal plasma usually occurs in the range of 10⁴K. An interesting concept consists of building a cylinder with the outer surface acting as a grounded tube electrode and to insert in the center of the tube a rod electrode and fill back the tube with catalyst as a honeycomb or layered structure. The rod electrode is proposed to be hollow and internally air cooled to sustain the high temperatures of the flue gases. A section of the rod electrode is perforated to release some air in the catalyst honeycomb or layered to discharge a measured quantity air from the compressor and complete the oxidation of Volatile Organic Compounds.

### REFERENCES

Catalytic converter|Emissions Control, Pollution Reduction & Automotive Technology|Britannica—https://www.britannica.com/technology/catalytic-converter
Liu Y, Sun X, Sethi V, Nelianda D, Li Y G, Wang L. Review of modern low emissions combustion technologies for aero gas turbines, Progress in Aerospace Sciences, Vol. 94, October 2017, pp 12-45, https://doi.org/10.1016/j.paerosci.2017.08.001
Cohen H, Rogers G. F. C, H. I. H. Saravanamuttoo. 1978. Gas Turbine Theory. Longman
Selective catalytic reduction—Wikipedia—https://en.wikipedia.org/wiki/Selective_catalytic_reduction
James E. Parks II, H. Douglas Ferguson III, John M. E. Storey—NOX REDUCTION WITH NATURAL GAS FOR LEAN LARGE-BORE ENGINE APPLICATIONS USING LEAN NOX TRAP AFTERTREATMENT—Oak Ridge National Laboratory, 2360 Cherahala Blvd., Knoxville, TN 37932
Imanaka N. & T. Masui—Applied Catalysis A: General—Publisher: Elsevier—Date: 26 Jul. 2012
Hicks Y. R., C. M. Heath, R. C. Anderson, and K. M. Tacina—Investigations of a Combustor Using a 9-Point Swirl-Venturi—Fuel Injector: Recent Experimental Results
Abulnaga B. E. 2021—Slurry Systems Handbook—McGraw Hill Books.
https://ntrs.nasa.gov/api/citations/20120008517/downloads/20120008517.pdf
Jonsdottir, H. R., Delaval, M., Leni, Z. et al. Non-volatile particle emissions from aircraft turbine engines at ground-idle induce oxidative stress in bronchial cells. Commun Biol 2, 90 (2019). 342 https://doi.org/10.1038/s42003-019-0332-7
Zhang, Yi & Li, Kungi & Chen, Haoran & Pan, Yuanfeng & Xiao, Huining & Guo, Hua. (2016). Agglomeration of ultra-fine particles from flue gas in coal-fired power plant using polymeric flocculants. 10.2991/13csee-16.2016.29.
Pasquiers, S. Removal of pollutants by plasma catalytic processes—The European Physical Journal Applied Physics, Volume 28, Issue 3, December 2004, pp. 319-324
EPA—The Clean Air Technology Center (CATC)
U.S. Environmental Protection Agency (E143-03)—2005—Using Non-Thermal Plasma to Control Air Pollutants—EPA-456/R-05-001
Steinwandel. J, E. Bayer “Device for the emission reduction of a turboshaft engine and corresponding method”—European Patent EP 2 392 796 A1.—filed Jun. 7, 2010
Galligan P. M. Aircraft Air Treatment Catalysts, Systems and Methods—US patent US20100152032A1—assigned to BASF Catalytic LLC filed Dec. 16, 2008—abandoned.
Willis J. W, P. Berner, G. Pont and J, Wacknov “Integrated Power Generation System with Catalytic Reactor”—US Patent Application 2004/0100101 A1 Published May 27, 2004
R. W Gordon and R, Chute—Co Generator Utilizing Micro-Gas Turbine Engine US Patent Application 2002/0095939 A1 Published Jul. 25, 2002
Rubin M. Power generating device and method, European Patent Application EP0271369 A2—date of publication Jun. 15, 1988
General Electric—Gas turbine catalytic combustor with pre-burner with reduced NOx generation Patent JP2591866B2
Schiling P. E and J. A. Laurelli. Catalytic Combustion System for a stationary combustion turbine having a transition duct mounted catalytic element—U.S. Pat. No. 4,413,470 Nov. 8, 1983

### BRIEF DESCRIPTION OF THE DRAWINGS

FIG. 1 shows a layout of an aircraft gas turbine powerplant driving a propeller with 8 combustion tubes around the gas turbine. The drawing shows an example of the invention with a propeller, compressor stages, combustion tubes, pollution control chambers with catalyst and non-thermal plasma application, dilution air and flue gas manifold, turbine stages

FIG. 2 shows a bloc diagram for the combustion system with air pre-heated by the exhaust of the power take off turbine through a rotary heat exchanger, pollution abatement on discharge of combustion tube through a chamber full of catalyst to which non-thermal plasma current is applied, and bypass dilution air to cool flue gases before entering the turbine stage.

FIG. 3 shows details of the combustion system operating at subsonic speed with air pre-heated by the exhaust of the power take off turbine through a rotary heat exchanger, pollution abatement on discharge of combustion tube through a chamber full of catalyst to which non-thermal plasma current is applied, and bypass dilution air to cool flue gases before entering the turbine stage.

FIG. 4 shows the embodiment of the combustion tube operating at supersonic speed when installed on the discharge of a supersonic compressor.

FIG. 5 shows the embodiment of the invention with a number of combustion tubes to be installed in parallel inside a wing.

### DETAILED DESCRIPTION OF THE INVENTION

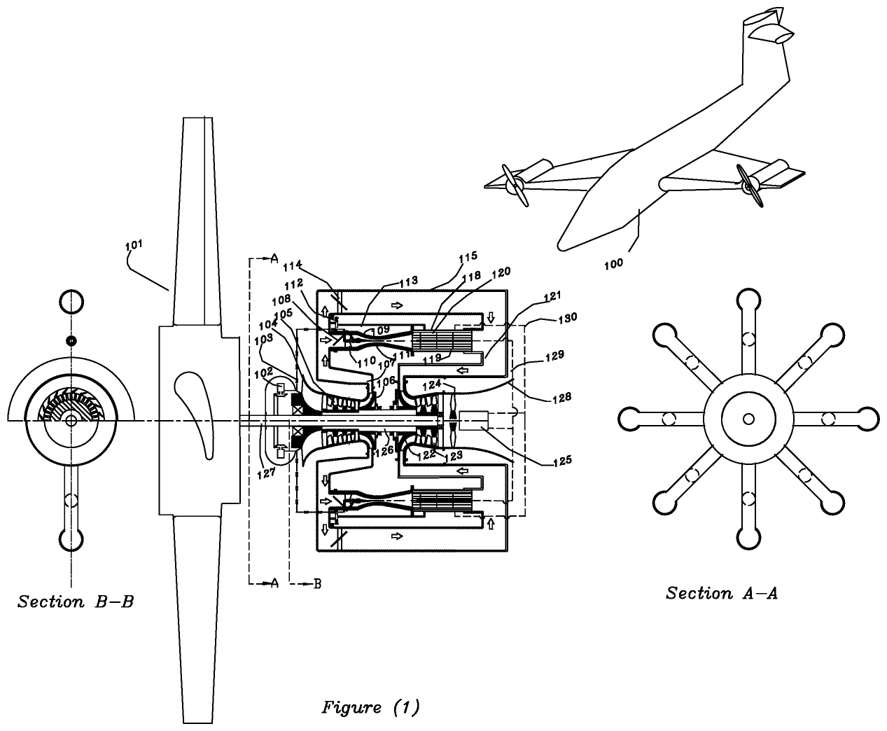

FIG. 1 shows an embodiment of an aircraft powerplant with multiple combustion tubes and bypass manifolds on the periphery of the compressor and turbine spools driving a propeller (101) of an aircraft (100). The shaft (127) drives through a gear box a jet fuel pump system (102) to each combustor through a dedicated fuel line (103). Air enters the powerplant through a bell mouth shaped inlet (104) into a multistage axial flow compressor (105), followed by a centrifugal compressor stage (106). At the exit of the compressor, air is transferred through a duct manifold (107). At the inlet of each combustor, a control valve (108) directs the amount of air for combustion at the stoichiometric ratio into the combustor (109), while the rest of the dilution air is sent to a common conduit (115), through a control valve (114). Fuel is injected through a nozzle at the center of an inlet swirler (110). The combustor is lined with refractory lining (111) to sustain the flue gas temperatures of 1800 K. On the discharge of the combustion tube (109), a pollution abatement chamber is installed. The chamber consists of a circular electrode tube (118), a central electrode rod (119) and a honeycomb of catalyst (120). The outer wall of the electrode tube and the electrode rod are cooled by compressed air from the discharge of the compressor through a control vale (112) and a dedicated airline (113). The circular electrode tube (118) and central electrode rod (119) constitute the elements to apply Electric Current for non-thermal plasma treatment of pollutants in the flue gases. The flue gases at the exit from the pollution abatement chamber mix with dilution air through duct (115), into a cooling manifold (121) and diluted air and flue gases are transferred to the turbine stage (122) that drives the compressor stage through shaft (126). Hot gases are then directed towards the axial flow turbine (123) that drives the propeller through shaft (127). Hot gases leaving turbine (123) are directed towards a third spool turbine (124) driving a generator (125) for the non-thermal plasma system, feeding an electric current through electric lines (129) and (130). The flue gases and hot air are then discharged through the powerplant exhaust (128)

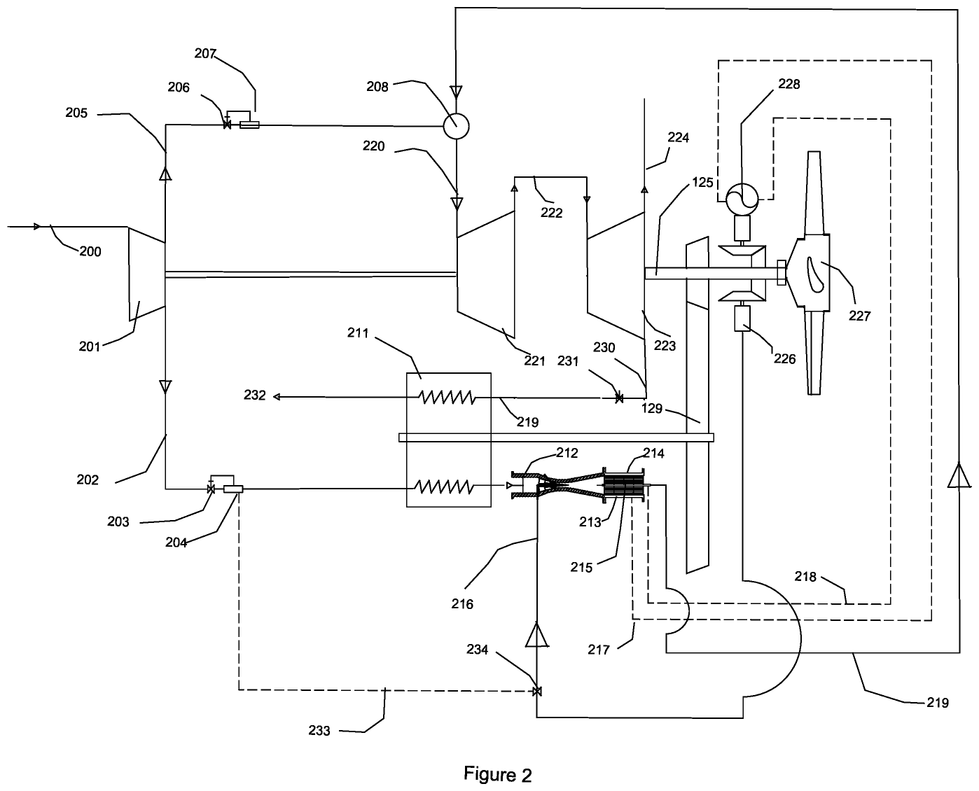

FIG. 2 shows a bloc diagram of the preferred embodiment of the aircraft twin spool powerplant. Air enters the powerplant through a manifold (200) into the compressor stages (201) and leaves as two compressed streams, primary combustion air (202) and secondary dilution air (205). Primary air is then divided into a number of combustion tubes, but in the figure only one will be described. Combustion air in stream (202) is controlled to be the mass of air required at the stoichiometric ratio of the combustor through the control valve (203) and a mass meter (204) that is also used to control flow from the fuel pump through wiring (233) and fuel valve (234). Dilution air stream (205) is controlled through control valve (206) actuated by mass flowmeter (207). Primary combustion air is directed into a rotary heat exchanger (211) to be pre-heated before entering the combustion tube (212) where fuel is added from piping (216). The flue gases products of combustion enter a pollution abatement unit downstream the combustion tube, consisting of a tube electrode casing (214), filled with catalyst (213) and a rod electrode (215) for non-thermal plasma application. The treated flue gases (219) mix with the dilution air (205) into a mixing manifold (208) to enter as a stream (220) at a temperature below the creep temperature limit of the compressor-driving turbine (221). Flue gases leave at reduced pressure (222) to expand further into the power take-off turbine (223) and discharge into the atmosphere as two streams (224) to the outside and stream (230) towards the heat exchanger (211) through control valve (231) and leave as cooled stream (231). The low-pressure turbine shaft (225) drives the heat exchanger (211) through a gear box (229), a fuel pump (226) and a non-thermal plasma generator (228) Wiring (218) and (217) from the generator feed the non-thermal plasma applicator downstream the combustion tube. Pump (226) feeds the combustion tube through piping (216) from the gas turbine fuel tank.

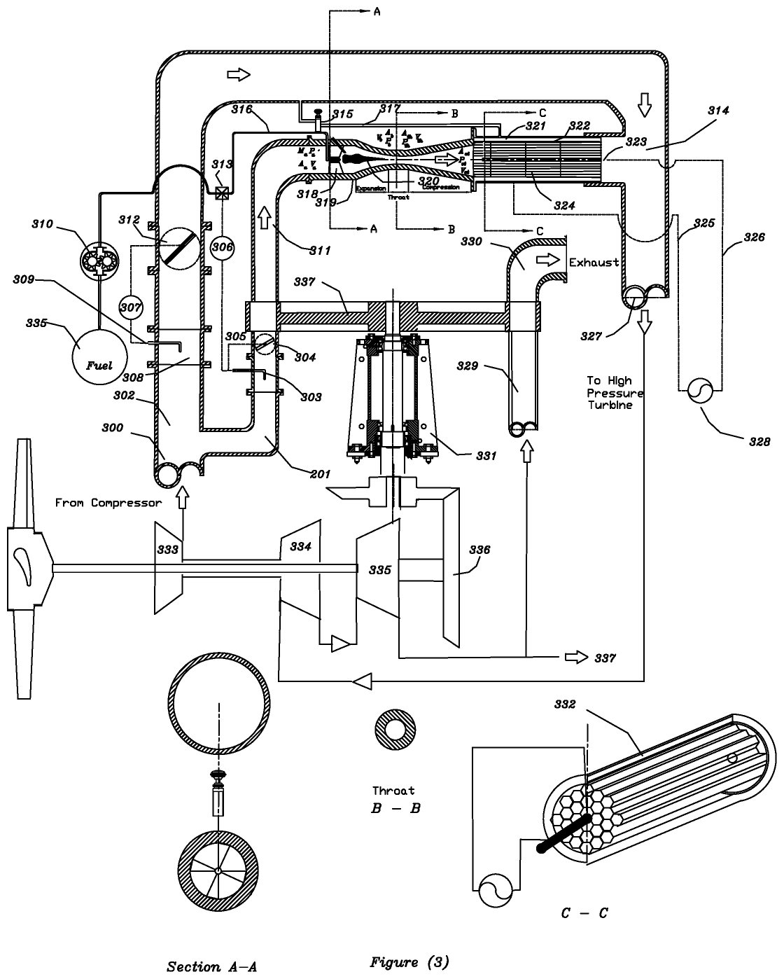

FIG. 3 represents another embodiment of the combustion system for flow from a subsonic compressor of an aircraft or industrial gas turbine with preheating of primary combustion air. Air enters from the compressor (333) through manifold (300) to be divided into primary combustion air (201) and secondary dilution air (302). Primary air passes through a mass meter (303) from which is a signal is used to control valve (304) through wiring (305) and the fuel control valve (313) through wiring (306). Secondary dilution air passes through a mass flowmeter (308) wired to a control valve actuator (312) through signal (307). Primary air after passing through the control valve (304) enters a rotary heat exchanger (337) preheated by a flow of flue gases from the power take turbine through conduit (329). Preheated combustion air is directed to the combustion tube (319) via conduit (311) and enters the combustion tube with mass Mₐ, Pressure Pₐ, cross-sectional area Aₐ and Velocity Vₐ. Swirling vanes (318) enhance mixing of air and fuel supplied from the fuel pump by piping (316), forming the flame (320). The combustion tube (319) is lined with ceramic to withstand the high temperatures of combustion. The cross-sectional area of the combustion tube reduces gradually towards the throat to transform a portion of the static pressure into dynamic pressure and entrain the fuel droplets at reduced pressure and at accelerated velocity. The cross section of the combustion tube goes through a transition at the throat of the tube, called “Expansion Length” before increasing to convert dynamic pressure into static pressure and slow the velocity of the flow as the products of combustion, through a section called “Compression Length”, enter the pollution abatement chamber consisting of an electrode casing (322), honeycomb or layered catalysts (324) and a tube electrode (323). Electric power is supplied from the electric generator (328) driven by on the power turbine (335) through wiring (325) to the tube electrode and wiring (326) to the tube electrode. Flue gases on the exhaust of the tube electrode mix with secondary air at the mixing tee (314) to cool down to the creep limit of the high-pressure turbine (334) to enter into the high pressure turbine through a common manifold (317). Hot flue gases from the power take-off turbine (335) pass through the heat exchanger (227) through gearbox (336) leave at the manifold (330) and remaining flue gases through manifold (337).

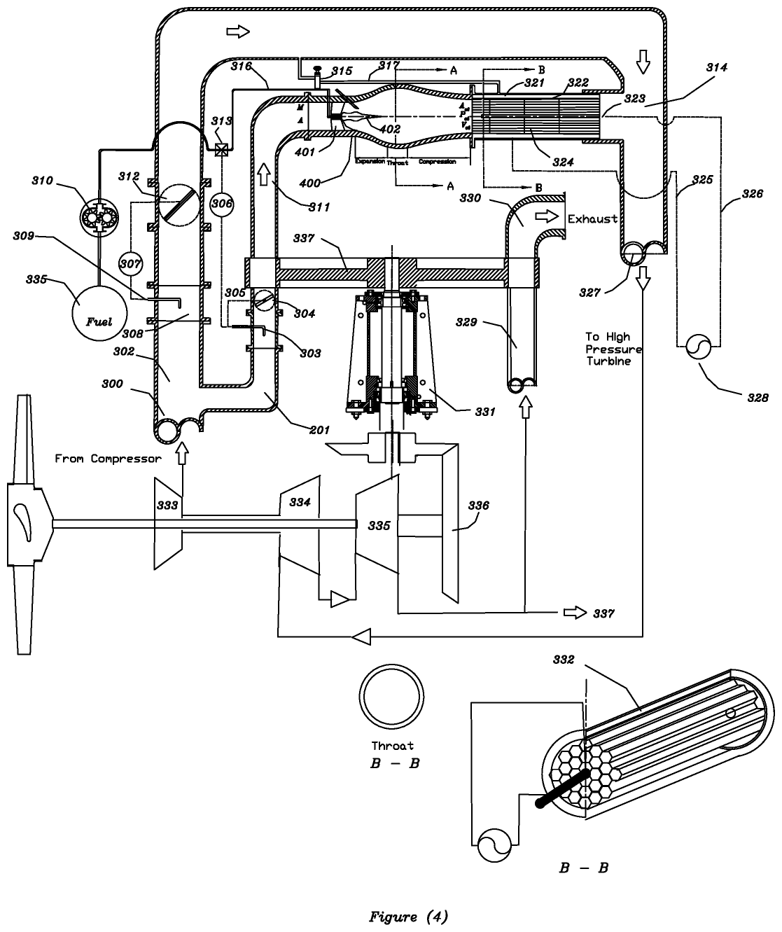

FIG. 4 represents another embodiment of the invention with flow through a supersonic combustion tube from a supersonic compressor of an aircraft or industrial gas turbine. Elements of the system that have been described in FIG. 3 are repeated but the ceramic lined combustion tube (400) changes from a straight section with swirling vanes through a gradual increase of the cross-sectional area through the expansion length to increase the velocity of gases, followed by a straight section through the throat and bu a gradual decrease of the cross=sectional area in the expansion length until it reaches the diameter of the electrode tube of the pollution abatement unit.

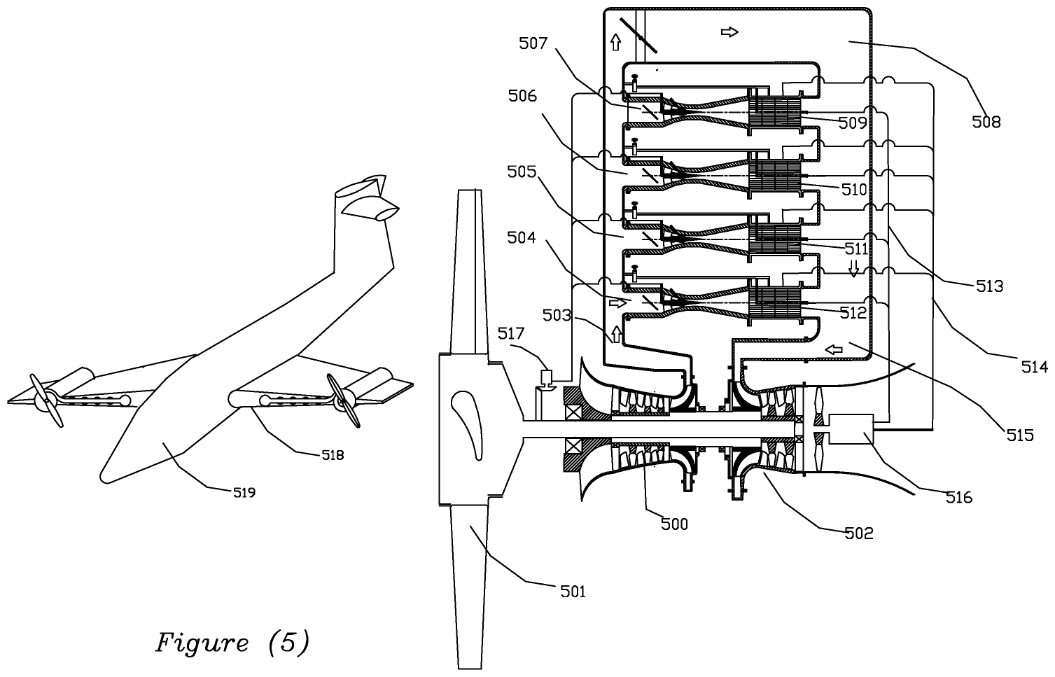

FIG. 5 presents another embodiment of the aircraft gas turbine propulsion system with multiple combustion tubes for primary combustion air with a common manifold for secondary dilution air, A propeller (501) is driven by a gas turbine system with air being discharged into a common manifold (503), from the compressor stages (500) with individual combustion tubes (504), (505), (506) and (507) with respective pollution abatement chambers (512), (513), (510) and (509) and flue gases from each combustor tube and respective pollution abatement chamber discharging into a common manifold (515) to the turbine stages (502), driving the propeller (501) as well as an electric generator (516) producing electric power for the non-thermal plasma treatment in the pollution abatement chambers (509), (510), (511) and (512) through the wiring (513) to the individual rod electrodes and wiring system (514) to the tube electrodes surrounding the catalysts in each pollution abatement chamber, with fuel being supplied to each combustor from a common fuel system (517). The system can be installed on the wing (518) of an airplane (519) to produce a low drag profile.

1. A combustion system with pollution abatement for an aircraft and industrial gas turbine whereby air from the compressor stages (106) is divided between a number of combustion units whereby each unit consists of a manifold (107) dividing pressurized air into primary combustion air and secondary dilution air in two parallel manifolds, with combustion air is controlled by a control valve (108) valve based on flow mass rates, whereby the amount of primary air is based on burning a gaseous or liquid fuel at the stoichiometric ratio in a ceramic lined combustion tube (109), with resultant flue gases from the combustion being treated in a pollution abatement chamber consisting of an tube electrode (118) and rod electrodes (119), with the space filled in between the electrodes with catalyst (120) where a non-thermal plasma electric current is applied to flowing flue gases with electric current, prior to mixing with secondary dilution air from the bypass manifold (115) at the discharge of the pollution abatement unit into a common manifold (121) to lower the temperature of the flue gases below the temperature limit for creep of the turbine metallic components, prior to entering the turbine stage (122), driving the compressor, the turbine (123) driving the propeller (101) and turbine (124) driving a generator (125) for non-thermal plasma application.

2. A combustion system with pollution treatment and heat exchange gas turbine whereby pressurized air delivered by the compressor stages (201) is divided into two streams, primary combustion air (202) and secondary dilution air (205), with said primary air being supplied at the and controlled through the control valve (203) and a mass meter (204), and being pre-heated by the turbine waste heat through a rotary heat exchanger (211), while secondary dilution air stream (205) is controlled through control valve (206) actuated by mass flowmeter (207), whereas primary combustion air after passing through the rotary heat exchanger (211) entering the combustion tube (212) where fuel is added from piping (216) to be burned at the stoichiometric ratio resulting into flue gases products of combustion entering a pollution abatement unit downstream the combustion tube, consisting of a tube electrode casing (214), filled with catalyst (213) and a rod electrode (215) for non-thermal plasma application by an electric current, producing de-contaminate flue gases (219) that are then mixed with the dilution air (205) into a mixing manifold (208) to enter as a stream (220) at a temperature below the creep temperature limit of the compressor-driving turbine (221), where they expand to leave at reduced pressure flow (222) to expand further into the power take-off turbine (223) and discharge into the atmosphere as two streams (224) to the outside and stream (230) towards the heat exchanger (211) through a control valve (231) and leave as cooled stream (231), with the power take-off turbine (223) and the turbine shaft (225) driving the heat exchanger (211) through a gear box (229), driving a fuel pump (226) and a non-thermal plasma generator (228) with wiring (218) and (217) from the generator feed the non-thermal plasma applicator downstream the combustion tube and with fuel pump (226) feeding the combustion tube through piping (216) from the gas turbine fuel tank.

3. An aircraft gas turbine as where air from compressor (323) is divided between secondary bypass air through manifold (302) and primary combustion air burning in a ceramic-lined combustion tube (319) at subsonic flow velocity and operating at the stoichiometric air to fuel ratio and designed to reduce the entry pressure and convert a portion into dynamic pressure through a gradual decrease of the cross sectional area downstream of the entry swirler and fuel nozzle (318) to accelerate the flow, entrain fuel droplets, complete combustion at reduced pressure over a length of expansion to reduce soot problems, followed by a throat section for propagation of the flame, and a final compression length, where the cross sectional area of the tube is gradually increased to convert dynamic pressure to static pressure and enter the pollution abatement tube electrode casing (322), at reduced velocity and match the velocity needed for contact with the catalyst (324) during non-thermal plasma application by electric current between the rod electrode (323) and the outer tube electrode (322), which is air-cooled by an external jacket (321).

4. An aircraft propulsion or industrial gas turbine in which each air from the compressor is divided between a bypass manifold and a ceramic-lined combustion tube (400) operating from a supersonic compressor at supersonic flow conditions through swirling vanes (401) and designed to achieve combustion at reduced pressure by using a divergent section with a gradual increase of cross sectional area to convert static pressure from the compressor into a high speed jet capable of entraining all droplets of fuel and reduce soot problems at high temperature, followed by a gradual decrease of cross section to convert back dynamic pressure into static pressure prior to entering a section for pollution abatement consisting of a chamber for hot temperature catalysts such as metal-oxide based and ceramic based catalysts and non-thermal plasma application.

5. An aircraft propulsion gas turbine in which each air from the compressor (500) is divided between a common bypass manifold (508) to a number of parallel combustion tubes (504), (505), (506) and (507) mounted inside the aircraft wing, whereas each combustion tube is connected downstream to a respective pollution abatement section (509), (510), (511) and (512) consisting each of a surrounding fluid cooled tube electrode, one and multiple central air cooled rod electrodes for application of a non-thermal plasma current between tube and rod electrodes, with the space between the rod electrodes and the surrounding tube electrodes filled with catalysts in a honeycomb and layered configuration, through which the flue gases from the combustor pass for chemical and electrical dissociation and conversion of the pollutants by combined catalytic conversion and non-thermal plasma application from a generator (516) before merging with cooling air from the bypassing manifold (508) into a temperature below the creep limit of the turbine stages (502), whereby the multiple combustion tubes and bypass manifold lay inside a wing (518) of an aircraft (519) to reduce overall profile drag.
